(19) United States
(12) Patent Application Publication
(10) Pub. No.: US 2005/0163211 A1
(43) Pub. Date: Jul. 28, 2005

(54) Scalable video transmission

(76) Inventor: Tamer Shanableh, Sharjah (GB)

Correspondence Address: MOTOROLA INC, 600 NORTH US HIGHWAY 45, ROOM AS437, LIBERTYVILLE, IL, 60048-5343, US

(21) Appl. No.: 10/506,344

(22) PCT Filed: Feb. 18, 2003
(86) PCT No.: PCT/EP03/01612

(51) Int. Cl. H04N 7/12

(52) U.S. Cl. 375/240.1; 375/240.12; 375/240.27

(57) ABSTRACT

A method (800) for improving a quality of a scalable video object plane enhancement layer transmission over an error-prone network. The enhancement layer transmission includes at least one re-synchronisation marker followed by a Video Packet Header and header extensions. A reference VOPs' identifier (e.g. ‘ref_select_code’) is replicated from the video object plane header into a number of enhancement layer header extensions (715). An error corrupting the reference VOPs' identifier is recovered (830, 840, 850, 860) by decoding a correct reference VOP's identifier from subsequent enhancement layer header extensions. Correct reference video object planes are identified (870, 880) to be used in a reconstruction of an enhancement layer video object plane in the scalable video transmission. This improves the error performance in an enhancement layer of video transmissions over wireless channels and the Internet where the errors can be severe.

### FIELD OF THE INVENTION

This invention relates to video transmission systems and video encoding/decoding techniques. The invention is applicable to a video compression system, such as an MPEG-4 system, where the video has been compressed using a scalable compression technique for transmission over error prone networks such as wireless and best-effort networks.

### BACKGROUND OF THE INVENTION

In the field of video technology, it is known that video is transmitted as a series of still images/pictures. Since the quality of a video signal can be affected during coding or compression of the video signal, it is known to include additional information or ‘layers’ based on the difference between the video signal and the encoded video bit stream. The inclusion of additional layers enables the quality of the received signal, following decoding and/or decompression, to be enhanced. Hence, a hierarchy of base pictures and enhancement pictures, partitioned into one or more layers, is used to produce a layered video bit stream.

A scalable video bit-stream refers to the ability to transmit and receive video signals of more than one resolution and/or quality simultaneously. A scalable video bit-stream is one that may be decoded at different rates, according to the bandwidth available at the decoder. This enables the user with access to a higher bandwidth channel to decode high quality video, whilst a lower bandwidth user is still able to view the same video, albeit at a lower quality. The main application for scalable video transmissions is for systems where multiple decoders with access to differing bandwidths are receiving images from a single encoder.

Scalable video transmissions can also be used for bit-rate adaptability where the available bit rate is fluctuating in time. Other applications include video multicasting to a number of end-systems with different network and/or device characteristics. More importantly, scalable video can also be used to provide subscribers of a particular service with different video qualities depending on their tariffs and preferences. Therefore, in these applications it is imperative to protect the enhancement layer from transmission errors. Otherwise, the subscribers may lose confidence in their network operator's ability to provide an acceptable service.

In a layered (scalable) video bit stream, enhancements to the video signal may be added to a base layer either by:
(i) Increasing the resolution of the picture (spatial scalability);
(ii) Including error information to improve the Signal to Noise Ratio of the picture (SNR scalability);
(iii) Including extra pictures to increase the frame rate (temporal scalability); or
(iv) Providing a continuous enhancement that may be truncated at any chosen bit rate (Fine Granular Scalability).

Such enhancements may be applied to the whole picture or to an arbitrarily shaped object within the picture, which is termed object-based scalability.

In order to preserve the disposable nature of the temporal enhancement layer, the H.263+ITU H.263 [ITU-T Recommendation, H.263, “Video Coding for Low Bit Rate Communication”] standard dictates that pictures included in the temporal scalability mode should be bi-directionally predicted (B) pictures. These are as shown in the video stream of FIG. 1.

FIG. 1 shows a schematic illustration of a scalable video arrangement 100 illustrating B picture prediction dependencies, as known in the field of video coding techniques. An initial intra-coded frame (I₁) 110 is followed by a bi-directionally predicted frame (B₂) 120. This, in turn, is followed by a (uni-directional) predicted frame (P₃) 130, and again followed by a second bi-directionally predicted/frame (B₄) 140. This again, in turn, is followed by a (uni-directional) predicted frame (P₅) 150, and so on.

As an enhancement to the arrangement of FIG. 1, a layered video bit stream may be used. FIG. 2 is a schematic illustration of a layered video arrangement, known in the field of video coding techniques. A layered video bit stream includes a base layer 205 and one or more enhancement layers 235.

The base layer (layer-1) includes one or more intra-coded pictures (I pictures) 210 sampled, coded and/or compressed from the original video signal pictures. Furthermore, the base layer will include a plurality of subsequent predicted inter-coded pictures (P pictures) 220, 230 predicted from the intra-coded picture(s) 210.

In the enhancement layers (layer-2 or layer-3 or higher layer(s)) 235, three types of picture may be used:
(i) Bi-directionally predicted (B) pictures (not shown);
(ii) Enhanced intra-coded (EI) pictures 240 predicted from the intra-coded picture(s) 210 of the base layer 205; and
(iii) Enhanced predicted (EP) pictures 250, 260, predicted from the inter-coded predicted pictures 220, 230 of the base layer 205.

The vertical arrows from the lower, base layer illustrate that the picture in the enhancement layer is predicted from a reconstructed approximation of that picture in the reference (lower) layer.

If prediction is only formed from the lower layer, then the enhancement layer picture is referred to as an EI picture. It is possible, however, to create a modified bi-directionally predicted picture using both a prior enhancement layer picture and a temporally simultaneous lower layer reference picture. This type of picture is referred to as an EP picture or “Enhancement” P-picture.

The prediction flow for EI and EP pictures is shown in FIG. 2. Although not specifically shown in FIG. 2, an EI picture in an enhancement layer may have a P picture as its lower layer reference picture, and an EP picture may have an I picture as its lower-layer enhancement picture.

For both EI and EP pictures, the prediction from the reference layer uses no motion vectors. However, as with normal P pictures, EP pictures use motion vectors when predicting from their temporally, prior-reference picture in the same layer.

Current standards incorporating the aforementioned scalability techniques include MPEG-4 and H.263. However MPEG-4 extends that temporal scalability such that the pictures or Video Object Planes (VOPs) of the enhancement layer can be predicted from each other. These standards create highly compressed bit-streams, which represent the coded video. However, due to this high compression, the bit-streams are very prone to corruption by network errors as they are transmitted. For example, in the case of streaming video over an error prone network, even with existing network level error protection tools employed, it is inevitable that some bit-level corruption will occur in the bit-stream and be passed on to the decoder.

To counter these bit-level errors, the coding standards have been designed with various tools incorporated that allow the decoder to cope with the errors. These tools enable the decoder to localise and conceal the errors within the bit-stream.

The MPEG-4 standard defines three tools for error resilience of video bit-streams. These are re-synchronisation markers, data partitioning (DP) and reversible variable length codes (RVLCs). These tools are defined for use in the base layer. However, the current MPEG-4 standard is currently considering the use of re-synchronisation markers within the scalable enhancement layers.

Of particular interest is the Video Packet error resilience tool of such video bit-streams, which contain a periodic re-synchronisation marker useful for recovering from errors occurring within a Video Object Plane (VOP), such as errors in motion parameters or Discrete Cosine Transform (DCT) coefficients. The Video Packet Header contains an optional Header Extension Code (HEC) that replicates some of the VOP header information including, but not limited to, time-stamps and VOP coding type. In contrast to re-synchronisation markers, HEC is a useful tool in the recovery of errors occurring in VOP headers rather than VOP bodies.

It is noteworthy that the VOP headers belonging to the enhancement layer contain an additional 2-bit field, termed a ‘ref_select_code’. This 2-bit field indicates the reference VOPs that the decoder should use to reconstruct the current VOP. This 2-bit field is absent from the base layer. The VOPs of the base layer are limited to either Intra or Predicted type VOPs. Therefore, each predicted VOP could be reconstructed from its immediately previous VOP, without the need for a ‘ref_select_code’ or similar, as used in the enhancement layer.

The MPEG-4 visual standard describes Video Packet Headers as follows (quote from Annex E, Page 109 of: ISO/IEC JTC 1/SC 29/WG 11 N2802, “Information technology—Generic coding of audio-visual objects—Part 2: Visual,” ISO/IEC 14496-2 FPDAM 1, Vancouver, July 1999):

“The video packet approach adopted by ISO/IEC 14496, is based on providing periodic re-synchronisation markers throughout the bitstream. In other words, the length of the video packets are not based on the number of macroblocks, but instead on the number of bits contained in that packet. If the number of bits contained in the current video packet exceeds a predetermined threshold, then a new video packet is created at the start of the next macroblock.”

Referring now to FIG. 3, a typical video packet 300, according to the aforementioned MPEG-4 standard, is illustrated. A re-synchronisation marker 310 is used to distinguish the start of a new video packet 300. This re-synchronisation marker 310 is distinguishable from all possible Variable Length Codes (VLC) code words, as well as the Video Object Plane (VOP) start code.

Header information 350 is also provided at the start of a video packet 300. The header 350 contains the information necessary to re-start the decoding process. The header 350 includes:
(i) The macroblock address (number) 320 of the first macroblock of data 360 contained in the video packet 300,
(ii) The quantization parameter (quant_scale) 330 necessary to decode that first macroblock of data 360, and
(iii) The Header Extensions 340 including the Headers Extension Code (HEC).

The macroblock number 320 provides the necessary spatial re-synchronisation whilst the quantization parameter 330 allows the differential decoding process to be re-synchronised. The Header Extension Code (HEC), following the quantization parameter 330, is a single information bit used to indicate whether additional information will be available in the header 350.

If the HEC is equal to ‘1’ then the following additional information is available in the packet header extensions 340:

Modulo time base, vop_time_increment, vop_coding_type, intra_dc_vlc_thr, vop_fcode_forward, vop_fcode_backward.

The HEC enables each video packet (VP) 300 to be decoded independently, when its value is ‘1’. The necessary information to decode the VP 300 is included in the HEC field, if the HEC is equal to ‘1’.

In a video picture, termed Video Object Plane (VOP), a series of resynchronisation markers, followed by a succession of VP headers and subsequent macroblocks of data are transmitted (and therefore received). The initial header of such a video picture is a VOP header (not shown). The VOP header includes information such as: start code for the video sequence, a timestamp, information identifying the coding type, information identifying the quantization type, etc. Hence, a decoder correctly decoding the VOP header can subsequently correctly decode the remaining transmission of successive VPs 300. If the VOP header information is corrupted by the transmission error, the errors can be corrected by the Header Extensions' information, which replicates some, but not all, of the VOP header information such as timestamps and VOP coding type.

As indicated above, VOP headers within the enhancement layer contain one additional 2-bit field, termed a ‘ref_select_code’ field. The HEC has been designed for base layer use, and therefore if HECs are incorporated in the enhancement layer then the ref_select_code will not be replicated.

The inventor of the present invention has recognised that if the ‘ref_select_code’ field in an enhancement layer VOP header was subject to network errors, either directly or due to header corruption, then the decoder will not be able to identify the correct reconstruction sources of the underlying VOP. An error in this regard will not only cause quality degradations to the underlying VOP but will also permeate to successive VOPs due to the inherent nature of inter-frame prediction.

Depending upon the scalability mode used in the enhancement layer VOP, the 2-bit ‘ref_select_code’ field may have one of four distinct values—‘00’, ‘01’, ‘10’or ‘11’. In order to reconstruct a non-intra coded VOP, a decoder motion compensates (by shifting the underlying 8×8 or 16×16 block of pixels by the value of the associated motion vector) the previously decoded VOPs, according to the value of the ‘ref_select_code’ field. If the ‘ref_select_code’ field is corrupted or missing, the decoder will not be able to identify the reference VOPs. Critically, the underlying VOP will therefore not be decoded correctly. The inventor of the present invention has recognised that a variety of error scenarios may result from a corruption of the ‘ref_select_code’ field, as illustrated in FIG. 4.

Three scenarios 405, 450, 460 have been recognised for errors occurring in the ‘ref_select_code’ field of the VOP header in an enhancement layer transmission 410, as shown in FIG. 4. For each of the three scenarios, the enhancement layer 410 shows three enhanced predicted values 415, 420, 425, and a base layer 430 shows three predicted values 435, 440, 445.

The comparison error-free case is shown in field 405, where a ‘ref_select_code’ of Bₑ₊₁=‘01’ is indicated. In field 450, a header error in the Bₑ₊₁ field is shown. As a result, the decoder will incorrectly assume that the ‘ref_select_code’ of Bₑ₊₁=‘11’. In field 460, a header error in the Bₙ₊₁ field is again shown. As a result, the decoder in this case will incorrectly assume that the ‘ref_select_code’ of Bₑ₊₁=‘10’.

It is noteworthy that the encoder selects the ‘ref_select_code’ on a VOP basis, which implies that this field can be changed from one VOP to another VOP according to the underlying implementation. Additionally, since the subsequent Bₑ₊₂ value 425 employs the corrupted VOP as a source of prediction then the error will start to propagate in the temporal domain causing noticeable visual distortions.

Referring now to FIG. 5 the objective effects caused by the corruption of the ‘ref_select_code’, according to the error scenarios 450 and 460 of FIG. 4, are illustrated. In FIG. 5, a test sequence Foreman is coded at 20 kbit/s per layer with temporal scalability. Errors in the enhancement layer were generated using a General Packet Radio System (GPRS) physical link layer simulator. The resultant Frame Erasure Rate (FER) is 5.6% and the Residual Bit Error Rate (RBER) is 0.1%. In FIG. 5, the ref_select_code of VOP number 176 is indicated as having been corrupted. FIG. 5 shows the impact on the amended Header extensions and the degradations associated with the use of the original Header extensions for error scenario (b) 450 and error scenario (c) 460.

In error scenario (b) 450, the ‘ref_select_code’ is assumed to have the value of ‘11’ hence the decoder selects VOP P_{b} of FIG. 4 as a forward source of reconstruction rather than Bₑ. Likewise in scenario (c) 460, the decoder selects VOP P_{b+1} of FIG. 4 as a backward source of prediction rather than P_{b}. In both cases the underlying VOP is not reconstructed correctly. Since the subsequent VOP employs the underlying VOP as a source of prediction, the error starts to propagate in the temporal domain.

The reasoning behind the planning and use of enhancement layers was based on the fact that enhancement layers were considered as an error resilience tool in themselves. Enhancement layer information contains visual information that enhances the decoding quality of the more important base layer. Hence, as enhancement layer information was not deemed essential, no further resiliency was anticipated.

Hence, the focus for higher levels of protection in a video bit sequence in current video communications systems is the base layer. This means that when an error occurs in an enhancement layer bit-stream, the decoder, wishing to keep the enhancement layer, has to conceal much more data, potentially in error, than it would have to if the error resilience tools could be used.

Thus, the inventor of the present invention has recognised and verified a number of current limitations of the MPEG-4 standard. The inventor of the present invention has identified that MPEG-4, as well as other similar scalable video technologies and standards, are deficient, if limited error resiliency tools are employed in enhancement layers, for example only using re-synchronisation markers within an MPEG-4 bit stream syntax's and the Simple Scalable Profile's. In particular, the inventor of the present invention is proposing a paradigm shift against the current focus for higher levels of protection in a base layer video bit sequence, to improvements in enhancement layer transmissions.

In summary, there exists a need in the field of video communications, and in particular in scalable video communications, for an apparatus and a method for improving the quality of scalable video enhancement layers transmitted over an error-prone network, wherein the abovementioned disadvantages with prior art arrangements may be alleviated.

Published patent application US-A-2002/0021761 describes a scalable layered video coding scheme. Re-synchronisation marks are inserted into the enhancement layer bitstream in headers.

Prior art document ‘Error resilience methods for FGS Coding Scheme’, Yan Rong, Tao Ran, Wang Yue, Wu Feng, Li Shi-Peng, Acta Electron. Sin. (China), January 2002, Vol. 30, No. 1, pages 102-104, describes a Fine Granularity Scalability (FGS) Coding Scheme. Re-synchronisation markers and a Header Extension Code are proposed in a new architecture of enhancement layer bitstream.

### STATEMENT OF INVENTION

The present invention provides a method for improving a quality of a scalable video object plane enhancement layer transmission over an error-prone network, as claimed in claim 1, a video communication system, as claimed in claim 5, a video communication unit, as claimed in claim 6, a video encoder, as claimed in claim 7, a video decoder, as claimed in claim 8, and a mobile radio device, as claimed in claim 9. Further aspects of the present invention are as claimed in the dependent claims.

In summary, an apparatus and a method for improving the quality of scalable video enhancement layers transmitted over an error-prone network by the use of re-synchronisation markers are described.

In particular, this invention provides a mechanism and method by which an improvement to Header extensions of Video Packet Headers is used for the enhancement layer. The improvement to Header extensions includes replicating a reference VOPs' identifier, such as the ref_select_code in an MPEG-4 system. In this manner, the decoder is able to identify the reference VOPs that should be used for the reconstruction of the current one.

### BRIEF DESCRIPTION OF THE DRAWINGS

FIG. 1 is a schematic illustration of a video coding arrangement showing picture prediction dependencies, as known in the field of video coding techniques.

FIG. 2 is a schematic illustration of a known layered video coding arrangement.

FIG. 3 illustrates a typical video packet according to the aforementioned MPEG-4 standard.

FIG. 4 illustrates a variety of error scenarios resulting from a corruption of the ‘ref_select_code’ field of a video object plane (VOP) header according to the aforementioned MPEG-4 standard.

FIG. 5 is a graph that illustrates simulated measurements of the variety of error scenarios of FIG. 4. Exemplary embodiments of the present invention will now be described, with reference to the accompanying drawings, in which:

FIG. 6 is a schematic representation of a scalable video communication system adapted to modify an enhancement layer of a video sequence in accordance with the preferred embodiment of the present invention.

FIG. 7 illustrates a VOP header and VOP body adapted to incorporate the preferred embodiment of the present invention.

FIG. 8 is a flowchart illustrating the preferred method of addressing errors in the ‘ref_select_code’ field of an enhancement layer VOP header in accordance with the preferred embodiment of the present invention.

FIG. 9 illustrates proposed syntax amendments to section 6.2.5.2 “Video Plane with short header, Video_Packet_Header( )” of the MPEG-4 visual standard, in accordance with the preferred embodiment of the present invention.

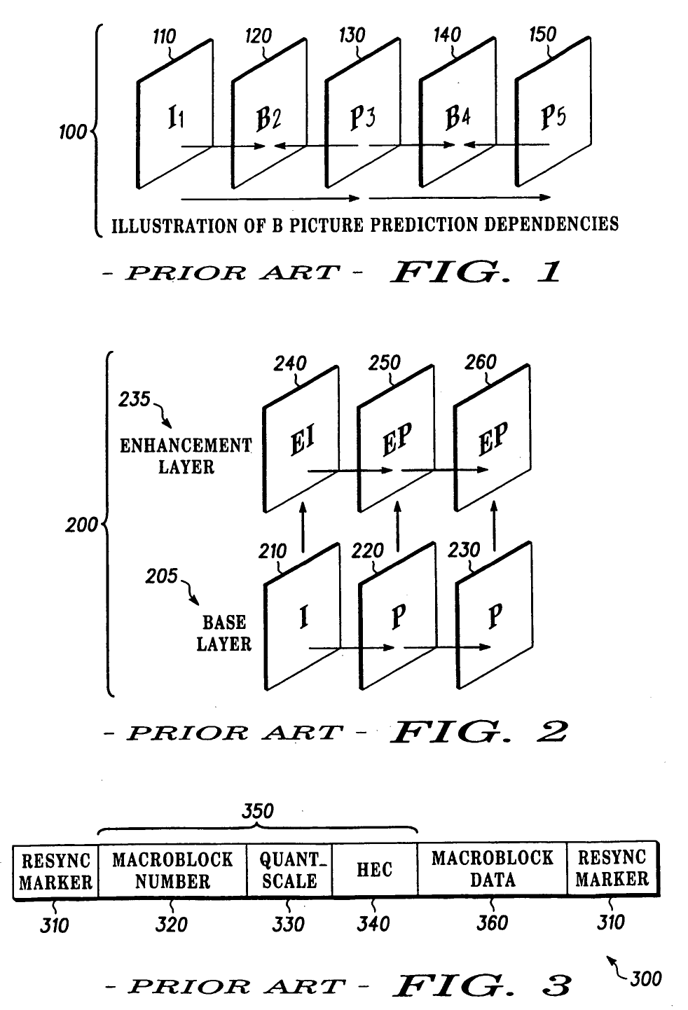

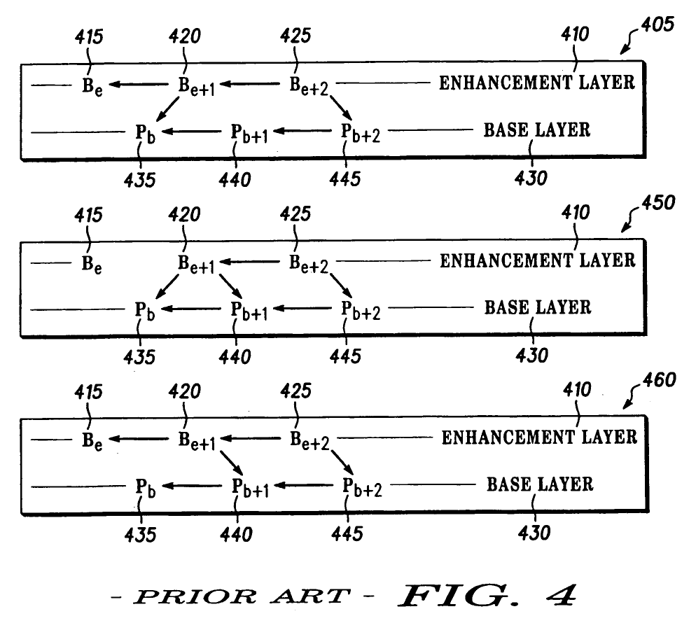

### DESCRIPTION OF PREFERRED EMBODIMENTS

The inventive concepts described herein can be applied to a variety of scalable encoded video techniques, such as SNR, temporal scalability, spatial scalability and Fine Granular scalability (FGS). The inventive concepts herein described find particular application in the current MPEG technology arena, and in future versions of scalable video compression.

The preferred embodiment of the present invention illustrates a mechanism and method by which an improvement to Header Extensions of Video Packet Headers is used for the enhancement layer. The improvement to Header extensions includes replicating header information, such as the ‘ref_select_code’ field from the enhancement layer Video Object Plane (VOP) header. In this manner, the decoder is able to identify the reference VOPs that should be used for the reconstruction of the current VOP.

Although the preferred embodiment of the present invention is described with reference to adaptation of header extensions such as the ‘ref_select_code’ of an MPEG-4 video system, it is within the contemplation of the invention that alternative techniques may be used in other scalable video communication systems. For example, it is envisaged that for systems that do not use the ‘ref_select_code’, the subsequent use of header extensions may encompass other parameters of the video object plane header such as timestamps of the reference VOPs.

Referring first to FIG. 6, a schematic representation of a video communication system 600, including video encoder 615 and video decoder 625, adapted to incorporate the preferred embodiment of the present invention, is shown.

In FIG. 6, a video picture F₀ is compressed 610 in a video encoder 615 to produce the base layer bit stream signal to be transmitted at a rate r₁ kilobits per second (kbps). This signal is decompressed 620 at a video decoder 625 to produce the reconstructed base layer picture F₀′.

The compressed base layer bit stream is also decompressed at 630 in the video encoder 615 and compared with the original picture F₀ at 640 to potentially produce a difference signal 650. This difference signal is compressed at 660 and transmitted as the enhancement layer bit stream at a rate r₂ kbps. This enhancement layer bit stream is decompressed at 670 in the video decoder 625 to produce the enhancement layer picture F₀″ which is added to the reconstructed base layer picture F₀′ at 680 to produce the final reconstructed picture F₀′″.

In accordance with the preferred embodiment of the present invention, the compression function 660 in the video encoder 615 has been adapted to modify header extensions of a Video Packet Header, or similar, of the base layer to be suitable for use within the enhancement layer bit-stream. Furthermore, the decompression function 670 in the video decoder 625 has been adapted to decode the modified header extensions of a Video Packet Header, or similar, of the enhancement layer bit-stream. In this manner, by provision of an improvement to the header extensions that includes replication of a reference VOPs' identifier, such as the ref_select_code, the decoder is able to identify the reference VOPs that should be used for the reconstruction of the current, potentially corrupted, VOP.

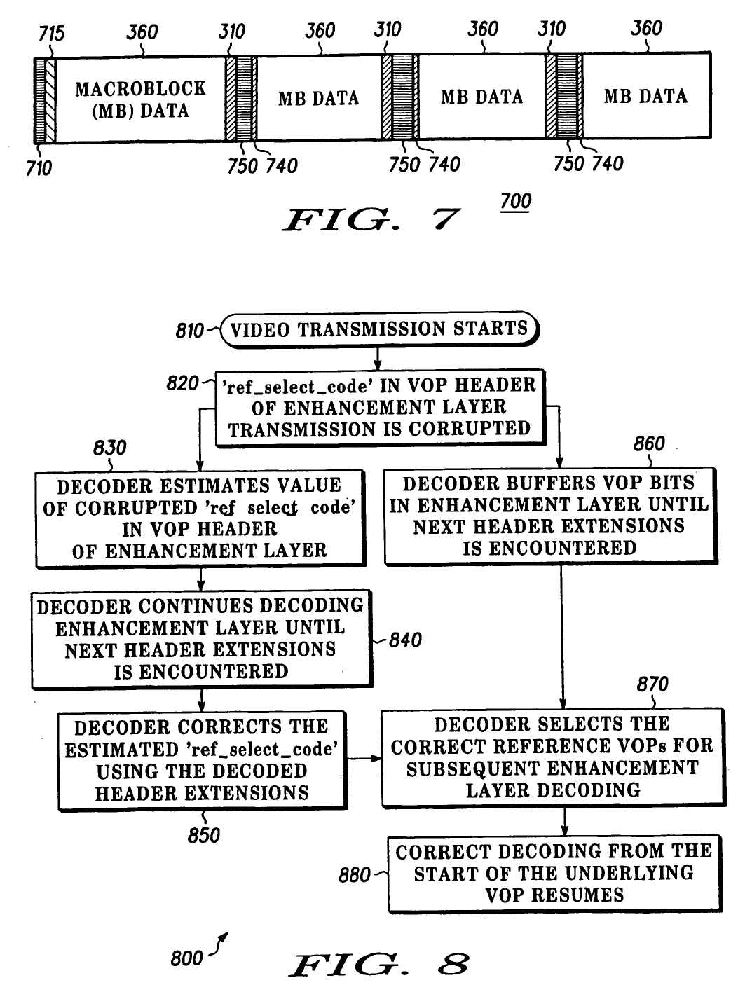

The modification of header extensions of a Video Packet Header is further described with regard to FIG. 7.

It is within the contemplation of the invention that alternative encoding and decoding configurations could be adapted to modify header extensions of a Video Packet Header, or similar, of the base layer to be suitable for use within the enhancement layer bit-stream. As a result, the inventive concepts hereinafter described should not be viewed as being limited to the example configuration provided in FIG. 6.

Referring now to FIG. 7, an enhancement layer VOP is shown, adapted in accordance with the preferred embodiment of the present invention. In summary, the header extensions of a Video Packet Header of a base layer video transmission has been amended to be suitable for use in the enhancement layer. The preferred implementation of the adapted header extensions of a VPH is in an MPEG-4 transmission, the proposed modified syntax of which is illustrated in FIG. 9.

The enhancement layer VOP video bit sequence 700 of FIG. 7 includes a VOP header 710 that includes the 2-bit ‘ref_select_code’ field 715. The VOP header 710 is followed by successive macroblocks of data 360. The VOP is divided into a number of Video Packets each starting with a re-synchronisation marker 310 and a Video Packet header 750.

In accordance with the preferred embodiment of the present invention, a number of VP headers 750 of the enhancement layer transmission have been adapted to include a modified header extensions 740. The header extensions 740 have been modified to replicate the ‘ref_select_code’ field 715 (reference VOPs' identifier) of the VOP header 710 of the enhancement layer transmission.

By replicating the ‘ref_select_code’ field 715 in a number of header extensions 740 of the enhancement layer Video Packet headers 750, the decoder becomes capable of recovering from errors affecting the VOP headers of the enhancement layer. In particular, if the ‘ref_select_code’ field 715 of the VOP header 710 belonging to the enhancement layer is corrupted then the decoder can replace it with correct values decoded from the modified header extensions 740 of the enhancement layer.

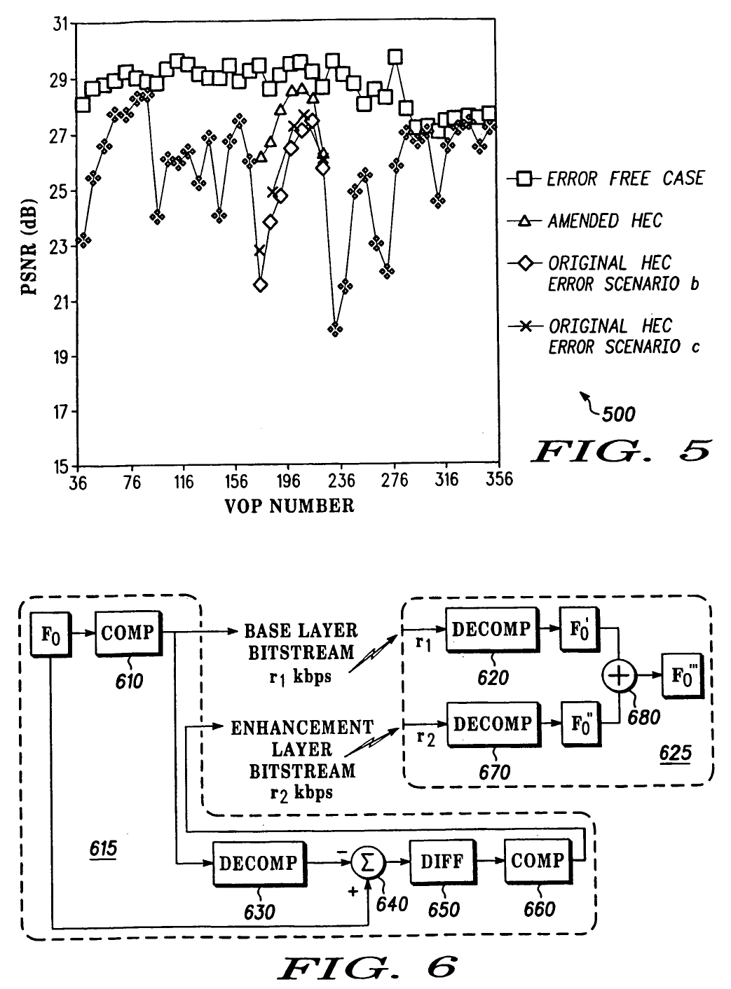

Amending the header extensions to replicate the value of the ‘ref_select_code’ of the VOP header 710 belonging to the enhancement layer prevents the degradations shown in FIG. 5. Once each enhancement layer header extensions are decoded, the decoder can select the correct reference VOPs' identifier and resume correct decoding of macroblocks of data in the enhancement layer. This can be effected by a short amendment to the MPEG4 video bitstream syntax code, as shown in FIG. 9.

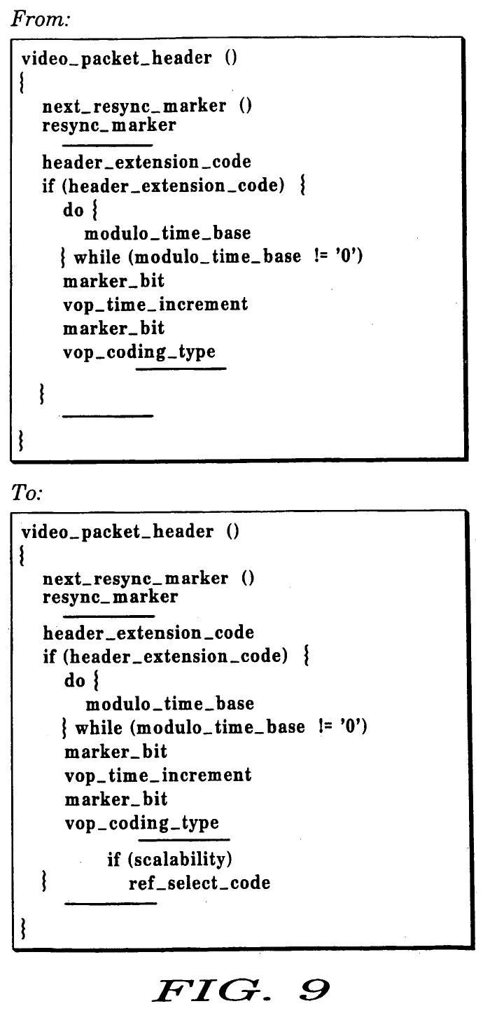

With this syntax code amendment in place, if an error occurs in the VOP header causing the corruption of the ‘ref_select_code’, then the decoder can follow one of the techniques described in FIG. 8.

Referring now to FIG. 8, a flowchart 800 illustrates the preferred method of addressing errors in the ‘ref_select_code’ field of an enhancement layer VOP header, in accordance with the preferred embodiment of the present invention. A scalable video transmission is commenced in step 810. An error occurs in the VOP header causing corruption of the ‘ref_select_code’, as shown in step 820. The decoder may then take any appropriate step of dealing with the enhancement layer bitstream until the next header extensions is decoded.

Two preferred alternative methods are illustrated in the flowchart 800. First, the decoder may estimate the value of the ‘ref_select_code’, as in step 830, for example by looking at previous ‘ref_select_codes’. This estimated ref_select_code might then be used until the decoder encounters the next header extensions, in step 840, the decoding of which indicates the correct ‘ref_select_code’ to be used. Upon decoding the header extensions, the decoder can correct_the value of the ‘ref_select_code’ in step 850. The decoder is then able to select the correct reference VOPs to use for subsequent enhancement layer decoding, as shown in step 870.

Alternatively, the decoder may decide to buffer the VOP bits up to the maximum size of the Video Packet, which is known in advance, until the next header extensions is to be decoded, as shown in step 860. The decoder may then correct its selection of the reference VOPs in step 860. Correct decoding of the enhancement layer transmission may then resume from the start of the underlying VOP, as shown in step 880.

The ‘ref_select_code’ is a 2-bit field. Advantageously, it follows that if the header extensions existed once per VOP, at a rate of ten frames per second at 40 kbit/s, then the excessive overhead caused by the proposed bitstream syntax amendment is 0.05%. This level of overhead is negligible. It is envisaged that only a single re-synchronisation marker, to indicate a Video Packet Header, followed by the adapted header extensions containing the replicated reference VOPs' identifier (e.g. ref_select_code), will benefit from the inventive concepts herein described. However, the invention will provide advantages over any number of re-synchronisation markers, headers and header extensions.

Finally, the applicant notes that future versions of the MPEG communication standard, such as the Joint Video Team (JVT) (from MEPG-4 and H.26L) configuration are currently under development. The present invention is not limited to the MPEG-4 standard, and is envisaged by the inventors as applying to future versions of scalable video compression.

It is within the contemplation of the present invention that the aforementioned inventive concepts may be applied to any video communication unit and/or video communication system. In particular, the inventive concepts find particular use in wireless (radio) devices, such as mobile telephones/mobile radio units and associated wireless communication systems. Such wireless communication units may include a portable or mobile PMR radio, a personal digital assistant, a laptop computer or a wirelessly networked PC.

Although the preferred embodiment of the present invention has been described with reference to the MPEG-4 standard, scalable video system technology may be implemented in the 3^{rd} generation (3G) of digital cellular telephones, commonly referred to as the Universal Mobile Telecommunications Standard (UMTS). Scalable video system technology may also find applicability in the packet data variants of both the current 2^{nd} generation of cellular telephones, commonly referred to as the general packet-data radio system (GPRS), and the TErrestrial Trunked RAdio (TETRA) standard for digital private and public mobile radio systems. Furthermore, scalable video system technology may also be utilised in the Internet. The aforementioned inventive concepts will therefore find applicability in, and thereby benefit, all these emerging technologies.

It will be understood that the mechanism and method to improve the quality of scalable video enhancement layers transmitted over error-prone networks, as described above, provides at least the following advantages:
(i) It improves the enhancement layer error performance in video transmissions over wireless channels and the Internet where the errors can be severe.
(ii) It enables scalable video technology to use error resilience tools in the highly competitive mobile multimedia market.
(iii) It further enables use of scalable video in conjunction with network Quality of Service (QoS) information in order to deliver optimal video quality to users in situations where network throughput and bit error rate (BER) are likely to vary.
   (a) Method of the Invention

Summarising the discussion above, a method improving a quality of a scalable video object plane enhancement layer transmission over an error-prone network has been described. The enhancement layer transmission includes at least one re-synchronisation marker followed by Video Packet header and header extensions. The method includes the steps of replicating a reference VOPs' identifier from the video object plane header into a number of enhancement layer header extensions. An error corrupting the reference VOPs' identifier is recovered by decoding a correct reference VOPs' identifier from subsequent enhancement layer header extensions. Correct reference video object planes are identified to be used in a reconstruction of an enhancement layer video object plane in the scalable video transmission.

The primary focus for the present invention is the MPEG-4 video transmission system. However, the inventor of the present invention has recognised that the present invention may also be applied to other scalable video compression systems.

(b) Apparatus of the Invention

A video communication system has been described that includes a video encoder having a processor for encoding a scalable video sequence having a plurality of enhancement layers. The enhancement layer transmission includes at least one re-synchronisation marker followed by a Video Packet Header and header extensions. Replicating means are provided for replicating a reference VOPs' identifier from a video object plane header into a number of enhancement layer header extensions; and a transmitter transmits the scalable video sequence containing the replicated reference VOPs' identifier. A video decoder includes a receiver for receiving the scalable video sequence containing the video object plane enhancement layer header extensions from the video encoder. A detector detects one or more errors in said reference VOPs' identifier in an enhancement layer of the received scalable video sequence and a processor, operably coupled to the detector, recovers from an error corrupting said reference VOPs' identifier by decoding a correct reference VOPs' identifier from subsequent enhancement layer header extensions when one or more errors is detected. The processor identifies correct reference video object planes to be used in a reconstruction of an enhancement layer video object plane in the scalable video transmission.

A video communication unit, an adapted video encoder, an adapted video decoder, and a mobile radio device incorporating any one of these units, have also been described.

Generally, the inventive concepts contained herein are equally applicable to any suitable video or image transmission system. Whilst specific, and preferred, implementations of the present invention are described above, it is clear that one skilled in the art could readily apply variations and modifications of such inventive concepts.

Thus, an improved apparatus and methods for improving the quality of scalable video enhancement layers transmitted over an error-prone network have been provided, whereby the aforementioned disadvantages with prior art arrangements have been substantially alleviated.

1. A method (800) for improving a quality of a scalable video object plane enhancement layer transmission over an error-prone network, the enhancement layer transmission including at least one re-synchronisation marker followed by a Video Packet Header and header extensions, the method comprising the steps of:
replicating a reference VOPs' identifier from a video object plane header into a number of enhancement layer header extensions (715);
recovering (830, 840, 850, 860) from an error corrupting said reference VOPs' identifier by decoding a correct reference VOPs' identifier from subsequent enhancement layer header extensions; and
identifying (870, 880) correct reference video object planes to be used in a reconstruction of an enhancement layer video object plane in the scalable video transmission;
wherein the scalable video object plane enhancement layer transmission is an MPEG-4 scalable video object plane enhancement layer transmission, or similar, and the reference VOP's identifier is a ‘ref_select_code’ field (715).

2. The method for improving a quality of a scalable video object plane enhancement layer transmission over an error-prone network according to claim 1, wherein the step of recovering includes the steps of:
estimating (830) a reference VOPs' identifier when an error has occurred in the reference VOPs' identifier;
decoding (840) the video object plane enhancement layer transmission until a video object plane enhancement layer header extensions is decoded; and
correcting (850) said estimated reference VOPs' identifier in response to a reference VOPs' identifier extracted from said decoded header extensions.

3. The method for improving a quality of a scalable video object plane enhancement layer transmission over an error-prone network according to claim 1, wherein the step of recovering includes the steps of:
buffering (860) video object plane enhancement layer transmission bits, until a video object plane enhancement layer header extensions is decoded, when an error has occurred in the reference VOPs' identifier; and
correcting (870) said reference VOP's identifier in response to a reference VOPs' identifier extracted from said decoded header extensions.

4. The method for improving a quality of a scalable video object plane enhancement layer transmission over an error-prone network according to claim 1, further comprising the step of:
selecting (870, 880) a correct reference VOP's identifier to decode subsequent enhancement layer transmissions.

5. A video communication system (600) comprising:
a video encoder (615) comprising:
a processor for encoding a scalable video sequence having a plurality of enhancement layers, wherein the enhancement layer transmission includes at least one re-synchronisation marker followed by Video Packet Header and header extensions;
replicating means for replicating a reference VOP's identifier from a video object plane header into a number of enhancement layer header extensions (715); and
a transmitter for transmitting said scalable video sequence containing said one or more reference VOPs' identifier; and
a video decoder (625) comprising:
a receiver for receiving said scalable video sequence containing said video object plane enhancement layer header extensions (715) from said video encoder;
a detector detecting one or more errors in said reference VOP's identifier in an enhancement layer of said received scalable video sequence; and
a processor operably coupled to said detector for recovering (830, 840, 850, 860) from an error corrupting said reference VOPs' identifier by decoding a correct reference VOP's identifier from subsequent enhancement layer header extensions when said one or more errors is detected, and identifying (870, 880) correct reference video object planes to be used in a reconstruction of an enhancement layer video object plane in the scalable video transmission;
wherein the scalable video object plane enhancement layer transmission is an MPEG-4 scalable video object plane enhancement layer transmission, or similar, and the reference VOPs' identifier is a ‘ref_select_code’ field (715).

6. A video communication unit (615, 625) adapted for use in the method of any of claims 1 to 4 or adapted for use in the communication system of claim 5.

7. A video encoder (615) adapted for use in the method of any of claims 1 to 4 or adapted for use in the communication system of claim 5.

8. A video decoder (625) adapted for use in the method of any of claims 1 to 4 or adapted for use in the communication system of claim 5.

9. A mobile radio device comprising a video communication unit in accordance with claim 6 or a video encoder in accordance with claim 7 or a video decoder in accordance with claim 8.

10. A mobile radio device according to claim 9, wherein the mobile radio device is a mobile phone, a portable or mobile PMR radio, a personal digital assistant, a lap-top computer or a wirelessly networked PC.
